(19) United States
(12) Patent Application Publication
(10) Pub. No.: US 2025/0133496 A1
(43) Pub. Date: Apr. 24, 2025

(54) MULTI-PROTOCOL COMMUNICATION DEVICE AND USE OF THIS DEVICE IN AN OBJECTTRACKING METHOD

(71) Applicant: GOODFLOOW, Nantes (FR)

(72) Inventor: Ronan LE ROY, NANTES (FR)

(21) Appl. No.: 18/695,304

(22) PCT Filed: Sep. 22, 2022
(86) PCT No.: PCT/EP2022/076436

§ 371 Date: Mar. 25, 2024

(30) Foreign Application Priority Data
Sep. 25, 2021 (FR) FR2110109

(51) Int. Cl. H04W 52/02; G06Q 10/0833; H04W 4/02; H04W 88/06

(52) U.S. Cl. CPC H04W 52/0229; G06Q 10/0833; H04W 4/027; H04W 88/06

(57) ABSTRACT

Multiprotocol communication device and use of this device in a method object tracking Communication device comprises: a wireless communication module configured to communicate according to the following communication protocols: a short-range communication protocol, a range of this protocol ranging from 0 to 10 meters, a long-range communication protocol, a range of this protocol ranging from 1 to 20 km, a Wake-Up Radio (WUR), an accelerometer to measure an acceleration of the device, a computerized decision module comprising a computerized AI module for classifying a movement configured to classify a movement of the device according to at least one acceleration of the device measured by the accelerometer, the computerized decision module being configured: to determine a state of the device based on a movement of the device classified by the computerized AI module for classifying a movement, and to control the wireless communication module and/or the Wake-Up Radio (WUR).

### FIELD OF INVENTION

The present invention relates to the field of telecommunications. It finds in particular an application in the field of logistics and more particularly in the tracking of fleets of logistics resources.

It relates to a communication device and a communication method and to a method for tracking packages of a logistics fleet.

### TECHNOLOGICAL BACKGROUND

Today, nearly 80% of industrial packaging used is made of cardboard and is single-use and therefore disposable. However, the use of reusable packaging makes possible to reduce CO2 emissions, reduce costs, and reduce financial assets.

However, we are not seeing a massive shift from disposable packaging to reusable packaging. This is explained by a return on investment that takes too long.

In fact, tracking and management of reusable packaging in circulation is impossible given the quantity and variety of companies through which the packaging passes.

As a result, the companies that own reusable packaging are completely blind and are unable to attribute responsibility for theft or loss to a supply chain partner.

Consequently, the only way that companies have to protect themselves from the risk of breakage of empty packaging the effects of which are equivalent to those of a breakage of the part itself, is to multiply by three or even four, the quantity of packaging in circulation in logistics loops.

Furthermore, there is no overall vision of the packaging in circulation in the same supply chain. For example, if a partner does not receive the packaging it was supposed to receive, it will not be able to return the same packaging itself. Currently, packaging is broken at the last moment. Furthermore, we found that:
This delays the delivery of goods and therefore delays the production of the factories that integrate them
The cost of treating this rupture is five times higher than that of the same rupture observed 5 days before

These problems with tracking and managing packaging considerably hamper the profitability of investment in reusable packaging to the point of causing some companies to return to the use of disposable cardboard packaging.

There is therefore a need for a solution that reduces the cost of using reusable packaging and eliminates the aforementioned problems related to their tracking and to their management. In other words, there is a need for packaging stock management or effective tracking of package responsibility to enable, in particular, the transition from disposable packaging to reusable packaging.

This will help promote the ecological transition from disposable cardboard to reusable industrial packaging.

Currently, several packaging tracking and/or management solutions exist, but they all have drawbacks.

Reusable packaging rental companies make packaging available to their customers at a given location and date to collect them on a given date and location. But they do not offer any means of reducing the quantity of packaging in circulation, because they are paid for the quantity of packaging rented in real time. They therefore do not offer any tracking and management tool for rented packaging.

This solution does not allow responsibility to be assigned to a supply chain partner.

Inventory management software, commonly called ERP from English: Enterprise Resource Planning (ERP) offers to manage packaging like goods but it does not allow effective tracking of packaging or packages. Indeed, the information recorded there is very often false because the entry is done manually, on a desktop computer, following an inventory, also manual, carried out a few hundred meters from the computer. Inventories are very often false. The data entered on paper before being entered is often done by another person.

As this value is not reliable, it no longer has any value and is no longer used by factory workers. It cannot under any circumstances be used as proof to attribute breakage, theft, loss or overstocking to anyone.

Another solution for tracking packages or packaging is to equip the packaging with communicating devices equipped with a geolocation device.

A first geolocation solution consists of equipping the packages with communicating devices having a range ranging from one to several tens of kilometers (for example, via a LORA communication protocol) and making possible to triangulate the signal emitted by the device attached to the packaging. However, this solution is not precise enough. Indeed, triangulation, for example LORA triangulation (TDoA LORA), triangulates the position of the communicating device according to the signal received on several antennas. However, for this to work, you need at least four antennas that receive the signal, which mostly happens in cities. But it is also in the city that we find the most reflective surface of the signal, which makes the triangulation false by several kilometers (2 to 7 km according to findings made by a large French distributor). In the countryside and peri-urban areas, the density of antennas being lower, the accuracy of the position is also very unreliable.

A second solution for geolocating packaging is to equip them with communicating devices equipped with a satellite geolocation device, more commonly called GPS module for Global Positioning System (GPS). These devices connected to GPS beacons fall within the definition of the Internet of Things (the Internet of Things or IoT). This term designates the interconnection between the Internet and physical objects, places and environments. The name also designates material devices and therefore also designates a growing number of objects connected to the Internet, thus allowing communication between our so-called physical assets and their digital existences. We therefore refer to these devices by the English acronym IoT or IOT. If this solution provides reliable positions when the packaging is outdoors, it consumes a lot of energy which further shortens the lifespan of the devices. Thus, to avoid too short a lifespan, these systems are configured to only give one position per day at a fixed time. They thus achieve an average autonomy of 3 years. But this poses several problems:
When communicating devices are turned off, they do not collect any information between emissions.
It is impossible to attribute responsibility for packaging 24/7 and everywhere in Europe due to gray areas due to energy savings made by the devices.
Events (truck loading, change of manager) are not observed in real time and only allow problems to be noted ex post, not to correct them and even less to anticipate them
The short lifespan of IoT devices creates a considerable mass of electronic waste. In fact, manufacturers do not replace the batteries of used IoT devices but the entire IoT. This forecast is confirmed by the GreenIt study which indicates that in 2025 pollution due to IoT will be greater than that caused by smartphones.

Finally, proximity geolocation solutions with an antenna on the walls (Gateway) identify the presence of packaging within a given perimeter around this antenna. The connected device fixed on the packaging emits a radio signal received by this beacon fixed on the walls of the place which hosts it. This system poses several problems:
Beacons must be placed on the walls wherever packaging is likely to pass, which requires a high investment in infrastructure.
The range of these beacons being limited, several hundred are needed to cover a factory of an automobile manufacturer, for example.
It is impossible for the company that owns the packaging to attach beacons to the walls of a factory that it does not own so it is unaware as soon as the packaging leaves its walls.
Any change in logistics flow is accompanied by a change of beacons on the walls of new frequented places, which removes all agility from logistics
Making such infrastructures profitable requires a considerable flow of packaging in front of each beacon and therefore to concentrate all the flows. This approach goes against a new logistics doctrine which aims to distribute flows between several suppliers in order to minimize the risks of closure of one or the other.

Finally, there are logistics visibility providers who aggregate the position of GPS beacons fitted to delivery trucks. They very precisely predict the arrival time of trucks, but suffer from inventory errors when loading and unloading trucks, once again making stock tracking imprecise and ineffective.

Also known is a communication device configured to form a cluster with one or more other nearby communication devices and monitor the presence, in this same cluster, of each communication device. This device is configured to provide information on the presence, in the cluster, of other communication devices to a third-party device.

However, this solution is not very agile because each communication device must be configured when creating the cluster. As a result, the cluster is not able to accommodate a new device without its prior parameterization and therefore human intervention.

In addition, these devices often communicate using master-slave communications protocols which requires the prior creation of a network between the members of this cluster. Finally, not all devices are identical to each other, which creates an additional lack of agility.

In addition, manufacturers do not change the battery of IoT devices when it is worn out. Indeed, as the labor and downtime costs of packaging are high, they prefer to replace the entire IoT to avoid problems due to poor sealing during reassembly which is a negative impact.

The invention therefore aims to resolve the drawbacks of existing solutions. For this, it offers a communication process which finds an ideal application to the technical problem of tracking and management of logistics stock without being limited to it.

Finally, the invention also aims to eliminate millions of ton of CO2 emitted following the use of single-use cardboard packaging.

### SUMMARY OF THE INVENTION

To the invention, we propose a communication device which can be in several different states and comprising:
a wireless communication module configured to communicate according to the following communication protocols:
   a short-range communication protocol, a range of this protocol ranging from 0 to 10 meters,
   a long-range communication protocol, a range of this protocol ranging from 1 to 20 km,
a Wake-Up Radio (WUR),
an accelerometer configured to measure an acceleration of the device,
a computerized decision module comprising a computerized Al module for classifying a movement configured to classify a movement of the device according to at least one acceleration of the device measured by the accelerometer,
   the computerized decision module being configured:
to determine a state of the device based on a movement of the device classified by the computerized Al module for classifying a movement, and
to control the wireless communication module and/or the Wake-Up Radio (WUR) according to a set of communication instructions defined by a state of the determined device.

According to one embodiment, the communication module is, in addition, configured to communicate according to the Wi-Fi protocol.
State No. 1 in which device 1 is stationary in a first stationary vehicle.
State No. 2 in which device 1 undergoes the movement of the first vehicle.
State No. 3 in which device 1 undergoes the movement of a second vehicle, and
State no. 4 in which device 1 is stopped.

According to one embodiment, we can provide that the short-range communication protocol uses a carrier signal with a frequency between 2 and 6 GHZ, and/or that the long-range communication protocol uses a carrier signal with a frequency between 600 MHz and 6 GHz.

According to one embodiment, a movement of the device is characterized by an exceeding of a predetermined acceleration threshold at a predetermined frequency of occurrence, and/or by several exceedance of a threshold and/or an acceleration variation threshold predetermined at a predetermined frequency of occurrence.

The predetermination of a predetermined acceleration threshold at a predetermined frequency of occurrence, and/or by several exceedances of a threshold and/or a predetermined acceleration variation threshold at a predetermined frequency of occurrence to characterize a movement or the detection of a movement makes possible to differentiate it from a simple shock that the device would have suffered. This also makes possible to obtain initial information useful for logistical monitoring since this movement is time-stamped.

Furthermore, by deduction, it is possible to know the simple shocks suffered by the device. Moreover, whether the device is on standby or on, the shocks it receives are time-stamped and their intensities are recorded by the device.

According to one embodiment, the decision module is configured to carry out a classification of the data collected.

According to one embodiment, the device further comprises a temperature sensor. This allows to detect a change in temperature and record it. A temperature difference, potentially unforeseen, is relevant information in the logistics tracking of a package: thanks to the device, it is then possible to know under which responsibility the temperature difference occurred. Thus, the device makes possible to collect another type of information that is very useful for logistics monitoring.

The advantages of the device will appear more clearly in light of the communication process in which two devices according to the invention intervene in particular.

However, the communication module making possible to communicate according to several communication protocols and the decision module configured to choose the protocol to use according to the communications instructions, making possible to use only a single electronic component to communicate according to different protocols. This significantly reduces the price of the device and also reduces its power consumption at the same time.

In addition, ideally, the communications instructions provide that the communication protocol used is determined based on the information or data to be sent and/or based on the device likely to receive the information or data sent.

The communications instructions provide for sending or not, via the long-range protocol, the information that it has collected and selects the information to be recorded or not for subsequent sending. All these features significantly reduce the energy consumption of the device.
at least two communications devices according to the invention,
a third communication device comprising a wake-up radio, a location module and a wireless communication module configured to communicate according to the following communication protocols:
the short-range communication protocol,
a telephone communication protocol, And
a remote server.

According to another aspect of the invention, there is provided a method of communication between:
a first device and a second device according to the invention and
a third device,
a remote server
   the method comprising the following steps:
the decision module defines the state of the device,
the decision module turns on and controls the communication module of the first device according to a set of communications instructions defined by the current state and determining:
   the transmission periods of a Wake-Up Beacon (WuB) wake-up radio signal),
   the data transmission periods, the communication protocol used by the transmission signal and the data transmitted by the signal,
   the data reception periods and the communication channel listened to during these periods, and/or
   the respective durations of the transmission and listening periods,
      if the second device receives the Wake-Up Beacon (WuB) wake-up radio signal emitted by the device, then the communication module of the second device turns on and communicates according to a set of communications instructions provided in the event of reception of a Wake-Up Beacon (Wub) wake-up radio signal and determining:
the data transmission periods, the communication protocol used by the transmission signal and the data transmitted by the signal,
the listening periods of a communication channel, and/or
the respective durations of the transmission and listening periods.

In other words, we propose a use of a system according to the invention. The communication method according to the invention is a possible use of the system according to the invention.

The communication method according to the invention makes possible to attach the first device and all at least one second device to an industrial site or to a truck using the site to which one of the devices was attached before becoming part of this cluster packaging. Thus, the home site of the device present before the others on the site can be applied to all the others packaging which have just moved. This happens without a geolocation system, with great precision while consuming as little energy as possible.

The position of the devices is deduced using that of the site to which they are attached.

The method mainly offers the following two advantages: consuming as little energy as possible by turning on the communications modules only when necessary (ie when a state of the device is defined) and using a relevant communication protocol for each communication carried out according the communication instructions defined by the state of the device.

Generally speaking, it makes possible to not use the energy resources of the energy reservoir (often an electric battery) of the first and second devices unnecessarily and only when necessary.

Ideally, the decision module sets the state of the device when the accelerometer of the first device detects movement of the first device, and then the accelerometer of the first device turns on the decision module of the first device and the computerized Al classification module with a movement of the module decision classifies the movement of the device according to the prediction models, or the decision module defines the state of the device when the accelerometer of the first device detects an absence of movement for a predetermined duration.

Thus, the method allows a cascade ignition of the different modules of the first and second devices when a state is defined.

First of all, the first device is turned on or woken up (ie switching on the decision module) only when necessary, ie when a movement is detected by the accelerometer which is still in standby or when the device returns to the stop: as soon as there is a relevant change, this change was characterized by a new state. In this context, the first device monitors events occurring in packaging 24/7.

Furthermore, with this same perspective, once the first device is awakened, ie as soon as the decision module is turned on, the wireless communication module of the first device is turned on only when the decision module detects a change of state of the device turned on.

Ideally, the set of communications instructions determined by the current state is as follows:
when the first device is in state no 1, no 2 or no 4,
the communication module of the first device transmits a wake-up radio signal to the second device and an identifier and then listens to the communication channel of short range,
if the communication module receives, via the short range communication protocol, an identifier of one or more communications devices awakened by the wake-up radio signal emitted, then
the communication module of the first device sends to the remote server, via the long-range communication protocol,
   a list of all identifiers received,
   a list of all shocks detected by its accelerometer, and
   a timestamp of the list.
when the first device is in state no. 3,
   the communication module of the first device transmits a wake-up radio signal to the third device and sends an identifier to the third device via the short-range protocol.

Thus, still with the same aim of only performing actions when relevant, the first device sends a Wake-Up Beacon (WUB) wake-up radio signal, which wakes up the devices in its surroundings and in particular at least a second device (then alternately transmits its identifier and starts listening). The at least second device only turns on when it receives the wake-up signal. The use of this technology provided by the invention makes possible to maintain the second devices in a sleep state all the time and therefore to save their energy consumption.

Ideally, the set of communications instructions expected when receiving a Wake-Up Beacon (Wub) wake-up radio signal is as follows:
the communication module of the second device, alternatively, transmits, via the short-range communication protocol, its identifier and listens to the short-range communication channel.

The identifier transmitted by the second device then makes possible to determine which devices were near each other.

We also notice here another characteristic of the communication method according to the invention: all the devices according to the invention have interchangeable roles. There is no master-slave relationship.

The method therefore allows, from the standby of the accelerometer, a cascade ignition circuit of the different modules of the first and at least one second device and this only when the ignition of each module is necessary.

This energy saving obtained thanks to this cascade ignition is made possible by the monitoring of the accelerometer but also by the decision module which detects changes of state.

Furthermore, as stated about the device according to the invention, the decision modules of the first and at least one second device also allow another advantage: choosing the appropriate communication protocol for each transmission of information and controlling the communication module. according to this choice. A first example is the choice of the WUR protocol by the decision module of the first device to wake up its environment and in particular the second device as has just been explained.

Likewise, the decision module chooses the short-range communication protocol for the response from at least one second device to the first device, it also chooses the long-range communication protocol for sending by the first device to the remote server/central of the information received from the at least one second device.

Ideally, if, after transmitting the wake-up radio signal, the communication module does not receive anything via the short-range communication protocol, then the communication module of the first device identifies a nearest wifi transmitter, and sends to the server remote/central, via the long-range communication protocol, an identifier of the identified wifi transmitter.

Indeed, if following the sending of the wake-up radio signal, the first device, then listening to its environment, does not receive any information, it is not possible to integrate it into a logical deduction chain allowing determining the home site step by step since no second device is present in the environment close to the first device. In this case, the position of the first device is determined by knowing the position of the nearest wifi transmitter.

Such a case can arise when the first device according to the definition of the method according to the invention is the first device to be positioned in a zone. This is particularly the case in factories or in loading/unloading areas.

In addition, it is possible that the third device sends its GPS position to the central or remote server (geolocation).

Still with this same economy in mind, the first and second devices do not include a very energy-consuming location module (GPS for example) as stated above in the disadvantages of the prior art. Only the third communication device is equipped with a location module.

However, the industrial site responsible for the first device and at least one second device can still be determined and timestamped. The industrial site to which the first and third devices are attached is known since the third device communicates according to the short-range protocol and the identifier of the user of the third device makes possible to know the company and the industrial site to which it is attached to. The geolocation of these two devices is therefore that of the industrial site to which the user of the third device is attached. In the event that the industrial site is poorly defined or unknown, it is possible to use the geolocation reported by the third device. In addition, the industrial site to which the at least one second device is attached can be estimated since the first device and the at least one second device have communicated with each other according to the short-range protocol (the first device has sent a wake-up signal in its environment, then started listening, and received an identifier from at least one second device) and that the home site of the first device is known (see previous sentence).

In addition, it is also possible that the home site of the at least one second device is known reliably at the time when the first device and it communicate with each other.

Thus, it is not the home site of the first device which makes possible to know or estimate the home site of at least one second device but the reverse.

In fact, it is always the home site of which the server is certain which is assigned to the other devices.

This principle of deducing step by step the home site of the first device and at least one second device makes possible to reliably know the home site of all the neighboring devices of a logistics fleet. In fact, the first device sends its identifier to the third. Furthermore, the second device sends the list of identifiers of the devices around it, of which the first device is a part. As a result, the server identifies that the first device and the third are on the same site because they have communicated by short distance radio.

Furthermore, the server knows that the first and second devices are attached to the same site thanks to the list of their neighborhood sent by each of them. So the first, second and third devices are attached to the same site at the same time.

Thus, we obtain an estimate of the home site of the first and all of the at least one second device without equipping these devices with a location module (GPS for example).

Furthermore, another advantage offered by the communication method according to the invention is that it does not require a predefined communication network between all the communicating devices, for example an ad hoc network or a mesh network. There is no pairing between communicating devices. The communication process also does not require the creation of a cluster between the communicating devices.

Finally, each device being strictly identical to the others, they are capable of locating themselves in relation to each other, without human intervention or prior configuration.

The communication method makes possible, in particular, to determine the home site of the first device. It is in this sense that it is useful to define states in which the first device is moving and in which it is at rest or stationary.

It is possible that the decision module of the first device compresses the information to be sent to the central server before sending it to the central server.

Even if the communication process provides, by definition, to send only information useful for location and logistical tracking, it may prove useful to compress the information before sending it to the central server.

Finally, according to another aspect of the invention, there is also provided a method for tracking objects of a logistics fleet comprising the following steps:
each object is equipped with a communication device according to the invention,
a third device is provided
a remote server is provided,
   the tracking method comprising the following steps,
communication according to the communication method according to the invention between the remote server, the third device and the devices equipping the objects,
from the information received by the remote server, time-stamped determination of a logistics site for each package by the remote server.

The deductive reasoning of proximity between a first device and a second device making possible to determine the home site of the first device and/or of at least one second device step by step applies on a larger scale: that of a fleet of logistics package.

This fleet is made up of packages which can all have a different origin and destination. However, they are interconnected by at least one communication as defined by the communication method between a first device and at least one second device.

All the information collected can then be processed from the remote (or central) server to which it was transmitted and makes possible to deduce all the time-stamped home sites of all the packages and all the events occurring for each logistics flow of a package.

An advantage enabled by the determination of the home site, and more generally by the reconstruction of the events of the logistics flow of the package, is to determine the natural and/or legal person who is responsible for the system.

Thus, if a package arrives defective to its final recipient it is possible to determine the moment of damage, under what responsibility this occurred. This also makes possible to identify logistical improvements to be made.

### DETAILED DESCRIPTION

### Devices

### Device 1, 11 or 12

The device 1 according to the invention comprises several modules or components: a communication module 2, an accelerometer 3, a computerized decision module 4 and a Wake-Up Radio (WuR).

Some components can be grouped into a single component.

In addition, the device 1 may further comprise a temperature sensor 5.

The communication module makes possible to communicate according to several following communications protocols:
a short-range communication protocol, a range of this protocol ranging from 0 to 10 meters,
a long-range communication protocol, a range of this protocol ranging from 1 to 20 km,

We specify that a range of 0 m corresponds here to a range less than 499 mm.

In addition, it is possible to configure the communication module so that it can also communicate using the Wi-Fi protocol.

The first device and the at least one second device according to the communication method according to the invention are both devices 1. They are identical to each other.

Device 1 is configured to use a Wake-Up Radio which will be described below. Likewise, it is configured to use iBeacon technology which will be described below.

### Protocol Frequency Bands

ISM (Industrial, Scientific and Medical) bands are frequency bands that can be used in a small space for industrial, scientific, medical, domestic or similar applications, with the exception of radiocommunication and radiodetermination applications for which the RED directive applies. For the European Union, the frequency bands and possible limit levels are defined in standard EN 55011. For the United States, publication part 18 of title 47 of the “code of federal regulations” (CFR) defines these frequency bands and the associated emission limit levels.

For example, in Europe, ISM frequency bands are defined in Table 1 of EN 55011:
HF 6.765-6.795 MHz (i.e 6.78 MHz±15.0 kHz)
HF 13.553-13.567 MHz (i.e 13.56 MHz±7.0 kHz)
HF 26.957-27.283 MHz (i.e 27.12 MHz±163.0 kHz)
VHF 40.660-40.700 MHz (i.e 40.68 MHz±20.0 kHz)
UHF 433.05-434.79 MHz (i.e 433.920 MHz +0.2%)
UHF 2.4-2.5 GHZ (i.e 2.450 GHz±50.0 MHz)
SHF 5.725-5.875 GHz (i.e 5.800 GHz±75.0 MHz)
EHF 61.0-61.5 GHz (i.e 61.25 GHz±250.0 MHz)
EHF 244.0-246.0 GHz (i.e 245.00 GHz±1.0 GHZ)

Short-range and long-range communications protocols can be used or transmitted in any of these frequency bands.

### Short Range Protocol

The devices 1 use the short-range communication protocol to communicate with each other.

The preferred frequency band for the short-range communication protocol is the UHF frequency band from 2400 to 2483 MHZ (S-band). WLAN networks (WIFI) and Bluetooth devices transmit in the 2.4 GHz band.

Another possible frequency band is the so-called 5.8 GHz band (from 5150 to 5350 MHz and from 5470 to 5725 MHz) or the so-called 5 GHz band (more precisely 5.150-5.725 GHz in Europe).

For example, the short-range communication protocol is, for example, a Bluetooth protocol and/or a Low Energy Bluetooth (BLE) protocol, and/or a Bluetooth 4.0 or Bluetooth Smart protocol. The communication module can use each of these short-range communication protocols or only one of them.

For example, the communication module of device 1 is configured to use the Bluetooth BLE communication protocol and the Bluetooth Smart communication protocol (with iBeacon technology).

Bluetooth is a communications standard enabling two-way exchange of data over short distances using UHF radio waves in the 2.4 GHz frequency band.

Compared to Bluetooth, BLE allows a throughput of the same order of magnitude (1 Mbit/s) for 10 times lower energy consumption. This makes possible to integrate this technology into new types of equipment such as watches, medical monitoring devices or sensors for athletes. The technology allows devices to connect within a radius of approximately 10 meters.

The transmission range according to short range communication protocol can be 0-20 m, 0-10 m, 0-5 m, 1 m, 2 m, 3 m, 4 m, 5 m, 6 m, 7 m, 8 m, 9 m or 10 m or any length included in a range defined by any of the limits mentioned above.

Likewise, we specify that a range of 0 m corresponds here to a range less than 499 mm.

For communication between devices 1 and the third device (described below), another short-range communication protocol based on iBeacon technology is used, Bluetooth 4.0 or Bluetooth Smart makes possible to operate iBeacon technology. Bluetooth 4.0 increases the connection range up to 100 meters and has a low-energy profile that significantly reduces power consumption (around a tenth) and thus increases battery life.

iBeacon technology (where “beacon” means beacon) is an indoor positioning system powered by low-energy, low-cost transmitters that can notify nearby devices equipped with these beacons of their presence. iBeacons can be used by Android or iOS. iBeacon is a technology that allows an iOS device or other hardware to send a signal to a nearby iOS device. The device can make an application respond to it and determine the position of the iBeacon.

### Long Range Protocol

The long-range communication protocol can, for example and without limitation, be transmitted on the 868 MHz and 915 MHz ISM radio bands.

The transmission range according to long range communication protocol can be 0-100 km, 0-50 km, 0-20 km, 0-10 km, 0-5 km, 1 km, 2 km, 3 km, 4 km, 5 km, 6 km, 7 km, 8 km, 9 km or 10 km or any length included in a range defined by any of the limits mentioned above.

Likewise, we specify that a range of 0 m corresponds here to a range less than 499 mm.

For example, the long-range communication protocol may be LORAWAN or LoRaWAN or LORA protocol.

LoRaWAN is the acronym for Long Range Wide-area network which can be translated as “long-range extended network”.

LoRaWAN is a telecommunications protocol allowing low-speed communication, by radio, of objects with low electricity consumption communicating using LoRa technology and connected to the Internet via gateways, thus participating in the Internet of Things.

### Wake Up Radio

A Wake-Up Radio (WUR) device allows continuous listening to the communication channel used by this device while having a consumption several orders of magnitude lower than that of traditional radios.

In fact, these devices only wake up the LOT device they equip when a specific signal, called Wake-Up Beacon (WuB), is detected. This signal is called a wake-up radio signal.

The wake-up radio signal is specific in frequency and/or amplitude, it is predetermined for each Wake-Up Radio it equips. Here, all Wake-Up Radios are configured identically.

When the Wake-Up Radio receives a signal with the correct content to wake the Wake-Up Radio, the Wake-Up Radio is awakened and the Wake-Up Radio then transmits an acknowledgment (ACK) to the transmitter of the specific signal, which is then the wake-up radio signal, to indicate that the wake-up radio signal has been received.

In other words, Wake-Up Radio allows you to wake up a device configured to communicate only if a specific signal is detected by it.

The communication module 2 of the device 1 is configured to communicate using this protocol. Thus, the communication module remains continuously listening to the channel specific to Wake-Up Beacon (WuB) signals and is awake if such a signal is detected or received.

One of the main advantages of WuR protocols is that they allow perfectly asynchronous communication. Additionally, when devices integrating a WuR chip have computing capabilities, only a specific node can be woken up by performing address decoding in the WuR. Indeed, the Wake-Up Beacon is a radio wave which contains a key recognized by the WuR which have been configured to only decode this key. WuRs are generally characterized by their short range and low throughput. This allows them to obtain low energy consumption,

Any other type of wake-up radio signal operating on the same principle can be used.

### MAC Multi Radio Layer

Furthermore, equipping the device 1 with a communication module 2 configured tocapable of communicate according to three or even four communications protocols simultaneously require designing a communication architecture specific to this multi-radio use.

This specific communication architecture makes possible to exploit the availability of several radio technologies in order to discover its environment and context on the one hand, and to select the most appropriate recipient/technology pair for each message sending on the other hand. This choice is made by decision module 4.

Indeed, the different communication technologies controlled by the communication module differ from each other in several points, including range, flow rate, and power consumption. The Multi-radio MAC layer makes possible to systematically obtain the best compromise to be estimated between cost and performance.

### Sensors: Accelerometer, Inertia Unit, Temperature Sensor

Device 1 is equipped with an accelerometer 3. An accelerometer is a sensor which, attached to a mobile or any other object, allows the linear non-gravitational acceleration of the latter to be measured.

We speak of an accelerometer even when it is in fact three accelerometers which calculate linear accelerations along three orthogonal axes. Likewise, when we seek to detect a rotation or angular speed, we speak of a gyrometer. More generally we speak of an inertial unit when we seek to measure all six accelerations.

However, in the context of this application, the term accelerometer is understood in its broadest sense and designates an inertial unit making possible to measure at least one among all six accelerations or simply an accelerometer.

According to the invention, the accelerometer remains on all the time. It consumes very little and has functions for determining whether thresholds have been exceeded. It has an internal clock.

In other words, accelerometer 3 is the watchman of device 1. It is he who allows device 1 to remain off when there is no change in the situation for device 1 and to turn on when a predetermined wake-up event occurs.

It is also possible to equip device 1 with a module for detecting the forks of a pallet truck or a forklift. For example, a magnetometer included in device 1 would make possible to qualify the presence of forks under the packaging in which device 1 is placed.

Finally, it is also possible to equip device 1 with a temperature sensor.

### Decision Module

The device 1 includes a computerized decision module 4. This decision module itself implements an artificial intelligence module (Al module).

This computerized decision module makes possible to interpret the measurements made by the device or more generally the data captured, i.e. interpret this quantitative data into qualitative information, then to control the actions of the device according to this information, and in particular the communications of the communication module 2.

Decision module 4 qualifies the state in which the device is based on:
Information collected by the different sensors.
The classification of some of the information collected into events by the Al it carries

In addition, it executes internal applications which allow it to control the operation of the embedded object.

Thus, in addition to simple detection, it allows the qualitative processing of measured detections, i.e. interpreting these detections into qualitative information about the device. It therefore translates measured, collected and analyzed information into events (qualitative or logical information).

Then, once the detections or data have been interpreted into events, it deduces the state of the packaging in which the device 1 is located. Then, it applies the communication instructions (listening to a predetermined channel or sending information, recipients, protocol used, etc.)

For example, decision module 4 determines whether it is relevant to communicate this information and, if so, what is the most suitable communication protocol for this communication.

In one embodiment, the computerized decision module 4 is equipped with a computerized artificial intelligence (Al) module implementing a deep neural network, for example a convolutional neural network.

Note that all the main events that occur in the packaging, qualified after interpretation carried out by decision module 4, are time-stamped by it. Indeed, when device 1 turns on following the detection of a wake-up event (see below), the clock turns on. In addition, since the accelerometer is equipped with its own clock, shocks detected but which do not wake up the decision module are also time-stamped.

### Description of AI and Its Functions

The AI module implemented by the decision module 4 makes possible to determine whether the captured data represents relevant information and, if so, what information. Subsequently, the decision module determines, on the basis of the information collected by the sensors and classified by the Al module:
whether it is appropriate to send this information, and by what communication protocol?
if it is preferable to store them to send them during a future communication and by what communication protocol?

For these two functions, the AI module has classification models (acquired following a period of supervised or unsupervised training).

The first allows it to classify the data captured into information. Note that classifying the data captured as “not relevant” is qualitative information, because this allows us to avoid sending unnecessary data. Thus, the Al module classifies the data captured into relevant information or not.

According to one embodiment, the interpretation consists of classifying the information collected into movements of the device, which once aggregated with other data collected by the sensors will make possible to define the state of the device and/or a change in state of the device according to the previously defined states.

The classified movement can be any movement for which the AI module has been previously trained to classify it. In particular, it can be vehicle movement (truck, car, Fenwick) or human movement.

The second allows it to identify, ie to classify according to the interpreted information, the communication protocol to use to send this information.

In addition, it is sometimes necessary to compress the data to be sent according to the determined communication protocol since, as a reminder, each protocol has its own transmission characteristics (rate, range, power requested, etc.). The IA module is configured to compress data using several methods.

The IA module identifies the best compression method or the combination of compression methods based on the nature of the data to be sent, and/or the communication protocol determined to send this data in order to arbitrate between energy consumed to compress or to transmit.

### Awakenings and Putting Decision Module 4 of Device 1 to Rest

### Alarm Clocks

The accelerometer and WuR sensor remain on constantly. They have two opposing objectives:
Continuously monitor the packaging in which device 1 is installed and therefore turn on device 1 during predetermined wake-up events for which information must be collected and analyzed
Keep the device asleep as often as possible to save battery power

These wake-up events can be characterized by one or more accelerometer measurements. This must wake up the device when a significant event occurs in the packaging in which it is located. On the other hand, it must not wake up the device if no significant event occurs.

In a first embodiment, a wake-up event is characterized by the detection of a movement. This movement (or the detection of this movement) is characterized by the detection of an exceeding of a predetermined acceleration threshold at a predetermined frequency of occurrence, and/or the detection of several exceeding of a threshold and/or of a predetermined acceleration variation threshold at a predetermined frequency of occurrence.

For example, if we are interested in the acceleration variation threshold, this predetermined wake-up acceleration variation threshold is generally quite low, for example between 1 g and 4 g.

However, the correct definition of this threshold is valuable since it is responsible for switching on or waking up the decision module and therefore for:
not to miss any significant event occurring on the packaging
Keep the device asleep most often so as not to consume energy and maintain a long lifespan.

The frequency with which this threshold is exceeded is also important because it makes possible to better define the conditions in which the device must turn on and those in which it must remain off. We are talking here about defining the signature of the movements that we wish to collect and analyze. These signatures are typically classified using the Al module subsequently.

For example, if the threshold is exceeded twice in five minutes, these are two isolated shocks which mean nothing. On the other hand, if it is exceeded 3 times in 1 minute, this means that the packaging is moving and that device 4 must therefore be turned on.

In a second embodiment, a wake-up event is characterized by the reception of a Wake-Up Beacon (WuR) wake-up signal by the Wake-Up Radio of device 1.

Decision module 4 is therefore switched on:
Either by significant excitation of the accelerometer: the acceleration threshold or the acceleration variation is predetermined,
Either by a Wub signal received by the WuR antenna of device 1.

Once decision module 4 is started, it will qualify the events that occur in the packaging and change the state of the device.

### Resting

There is a resting of the decision module specific to waking up by reception of the WuR signal

Concerning the awakening by the WuR signal, the devices 1 which have been awakened by the WuR cannot be awakened during a predetermined period (for example 2 minutes) if they have not been in movement in the meantime in order to avoid the unnecessary awakenings,

For example, if device 1 is in a moving truck (this situation is defined by a “Truck Movement” state as will be developed below), then the rules for waking up device 1 by the accelerometer change. Indeed, once a movement sequence is activated (and the state of the device modified as explained below), the rules for turning on the device by the accelerometer change. Thus, the device will remain off until the device remains off, ie the truck has stopped, for a predetermined duration.

On the other hand, for example, once underway in a truck, little significant information is to be collected in a truck until it stops, device 1 therefore remains turned off.

### Shocks and Temperatures

Deterioration of packaging due to shocks or of the goods they contain due to a break in the cold chain can only be taken care of once noted. One of the objectives is to qualify the person responsible and to inform the next site which will take responsibility for the packaging that the packaging has suffered shocks and/or that the goods have suffered a break in the cold chain. Another objective can also be to identify periods of time during which deterioration has occurred in order to better anticipate or even prevent them.

According to one embodiment, a shock threshold is programmed on the accelerometer of device 1. An acceleration greater than this value indicates that the packaging has suffered an impact. Each time it is observed, this data is time-stamped and stored pending a long-range transmission, whether the device is on (decision module 4 awake) or just in standby with only the accelerometer on.

A shock is different from a movement. As a reminder, a movement is characterized by the detection of exceeding a predetermined acceleration threshold, and/or the detection of several exceedances of a threshold and/or a predetermined acceleration variation threshold at a predetermined frequency of occurrence. Thus, a shock is characterized by a predetermined acceleration threshold greater than that characteristic of a movement or by a predetermined acceleration variation greater than that characteristic of a movement. Likewise, a shock is punctual unlike a movement.

The information qualifying each shock, its intensity and its date are recorded and transmitted during each long-range radio communication via the long-range communication protocol defined according to the communications rules of each state.

Likewise, the temperature is sent with each long-range transmission unless it has not changed by more than 0.5 degrees since the last transmission.

As will be detailed below, according to the communication rules specific to each state, long-range emissions are generated at the time of movement/stop phase changes and therefore potentially changes of managers.

It is to inform the next manager in the supply chain of the shocks suffered by the packaging he receives that this data is sent at this moment because it generates, at this moment, potentially actions to be produced by the users.

Likewise with regard to temperature information, it is at this moment that problems with cold chain disruptions are noted: goods unloaded outside and not in fridges/freezers or goods loaded in temperature-controlled transport including the fridge unit has not been turned on. This information makes possible to qualify these problems and inform the next manager in the supply chain.

### State and Change of State

Device 1 can be in several states. By “state”, we mean a physical situation in which the packaging is found or, in addition, by a place or an environment. Each state is qualified by information collected by the sensors of device 1 and, for some of it, analyzed by the IA module.

According to a particular embodiment, there are four states for the device 1:
State no. 1 “Vehicle 1 Pause or Unloading”: device 1 is stationary in a first stationary vehicle.
State no. 2 “Vehicle 1 in motion”: device 1 undergoes the movement of the first vehicle.
State no. 3 “Vehicle 2”: device 1 undergoes the movement of a second vehicle, and
State no. 4 “Intermediate stationary (Factory or Vehicle 1)”: device 1 is stopped.

According to a particular example of this embodiment, the states of device 1 are:
State “Truck Pause or Unloading”,
State “Truck in motion”
State “Fenwick”, and
State “Intermediate stationary (Factory or Truck)”

These four states are defined by decision module 4 according to one or more prediction models obtained at the end of a learning phase as explained in the Description of the AI and its functions section.

We will now describe its four possible states for device 1:
State “Truck Pause or Unloading”: device 1 is stationary in a stationary truck which:
Either is being unloaded,
Either whose driver takes a driving break (break)

The movement that device 1 will undergo following this stop will make possible to differentiate these two cases. The decision module is in a logical state of movement classification:
If the IA module classifies this movement suffered by a movement of a Fenwick then device 1 was in a “truck unloading” state and it is in the “Fenwick in motion” state.
If the IA module classifies this movement suffered by a movement of a truck then device 1 was in a “truck whose driver is taking a break” state and it is in the “Truck in Movement” state

Thus, the “Truck in Motion” and “Fenwick” states are defined as follows:

State “Truck in Motion”: The IA module has classified the movement that device 1 undergoes by a movement of a truck as seen above.
State “Fenwick”: the IA module has classified the movement that device 1 undergoes by a movement of an electric or hand forklift.

Finally, the “intermediate stationary (Factory or Truck)” state is defined as follows: The packaging is stationary either in a factory or in a truck.

In the same way as in the “Truck Pause or unloading state” state, it is the classification by the Al module of the movement that the packaging will undergo following this stop which will make it possible to differentiate the two cases:
If the IA module classifies the movement experienced by device 1 as being the movement of a Fenwick then device 1 was stopped in the factory.
If the IA module classifies the movement experienced by device 1 as being the movement of a truck then device 1 was stationary in a truck

This distinction made possible by the accelerometer and the decision module 4 is a first interpretation of data into relevant information.

Finally, the decision module 4 is configured to detect changes in state from the “Truck_Movement” state to the “Truck Pause or Unloading” state and from the “Fenwick Movement” state to the “Intermediate Immobile” state. (Factory or Truck)” thanks to the monitoring of a predetermined duration of stoppage or rather of absence detection of movement to be classified.

This absence of movement for a predetermined duration is detected using the accelerometer. Indeed, as a reminder, a wake-up event is characterized by the detection of an exceeding of a predetermined acceleration threshold, and/or the detection of several exceeding of a threshold and/or a variation threshold of predetermined acceleration at a predetermined frequency of occurrence. Thus, if for a specific period of time, no exceeding characteristic of an alarm clock is detected, the decision module concludes that the device is stopped and goes to rest.

This predetermined duration may be different for the two changes of state.

The changes of state are identified by the decision module 4 which was activated upon detection of a wake-up event and which received the data allowing it to produce this information; for example the accelerometer wakes up the decision module 4 then the Al module classifies the signal that the accelerometer emits and finally the decision module 4 identifies the current state and the previous one according to the rules stated above.

### Third Device 5

The third device 5 according to the communication method according to the invention is a third communication device 5 comprising:
a wireless communication module configured to communicate according to the following communication protocols:
   a short-range communication protocol,
   a telephone communication protocol,
a location module.

The short-range communication protocol is the same as that used by device 1. It therefore has the same general characteristics but can be configured differently for the third device 5.

As such, the communication module of the third device 5 is also configured to use the Bluetooth BLE communication protocol and the Bluetooth Smart communication protocol (with iBeacon technology).

According to one embodiment, the short-range communication protocol is a Bluetooth communication protocol or a Bluetooth low energy (BLE) communication protocol.

The telephone communication protocol is a classic communication protocol using known mobile networks. For example:
GPRS (or 2.5 G);
EDGE (or 2.75 G);
3G or UMTS;
HSDPA (or 3G+ or 3.5 G);
HSUPA and HSPA+ (or 3.75 G);
LTE and LTE Advanced (or 4G);
5G.

The location module is for example a classic satellite positioning system whose operating principle is based on the trilateration of synchronized electromagnetic signals emitted by the satellites.

According to one embodiment, it can run various software/applications using an operating system, and therefore in particular provide functionalities such as: calendar, television, calendar, web browsing, consultation and e-mail, dictaphone/tape recorder, calculator, compass, accelerometer, gyrometer, visual voicemail, and/or digital mapping.

In particular, according to one embodiment, the third device is configured to execute an application from which information about the device 1 can be provided and/or modified. For example, the information can be any type of information useful for logistics monitoring: name, volume, weight, origin, destination, responsible, location, state (empty/full), appearance etc.

The third device is also configured to read NFC tags and in particular an NFC tag of a package equipped with a device 1.

For example, the third device 5 is a smart phone or smartphone.

The third device 5 is configured to use iBeacon technology.

### Central Server or Remote Server

The central server 6 is a classic server comprising classic databases allowing it to record the information transmitted to it according to the communication method according to the invention.

The term “server” generally has two meanings in computing. By server we qualify not only the computer which provides the resources of a computer network, but also the program running on this computer. We give you the two definitions of a “server” below:

Server Definition (Hardware): a hardware server is a network of computers connected by a physical machine and on which one or more software servers operate. An alternative to the term server (Hardware) is “host”. In principle each computer is used with a software server.

Server Definition (Software): server software is a program carrying out network interactions with other programs called software clients. The service provided depends on the type of server software. The basis of network communication is this Client-server relationship. When exchanging data, different transmission protocols come into play.

Subsequently, the expression “central server 6” or the term “server 6” designates the two possible meanings.

It is connected to communications means by which it can communicate with the device 1 or the third device 5.

In addition, the central server is connected to a processing unit equipped with computer calculation means.

This processing unit processes the data or information received by the central server and makes logical deductions from the transmitted information.

This processing unit may be equipped with an artificial intelligence (AI) module. This Al module, different from the AI module embedded in decision module 4, makes possible to process the information collected according to a prediction model. This prediction model is preferably designed by the Al module in an unsupervised or untrained manner, ie from the sole reception of transmitted information not yet classified.

### Processes

The different communications devices (11,12) and the central server 6 interact with each other, i.e communicate with each other according to the following communication protocol.

We place ourselves in the context of a particular application of a communication process: the logistics tracking of 100 packages or packaging each equipped with a device 1.

The communication method concerns at least two devices 1, hereinafter the first device 11 and the at least one second device 12. There can be several second devices 12, the only limit is the communication range of the short-range communication protocol.

As part of the application to logistics tracking, a package 101 is equipped with the first device 11 and the packages 102 are equipped with a device 12.

### Communication Process

According to the first embodiment, the first device 11 comprises an accelerometer and the wake-up event is detected by it whatever the definition of this wake-up event detected by the accelerometer (see above).

In a first embodiment, the communication method comprises the following steps:
the decision module 4 defines the state of the device 11,
the decision module 4 turns on and controls the communication module 21 of the first device 11 according to a set of communications instructions defined by the current and determining state:
   the periods of transmission of a Wake-Up Beacon (WuB) radio signal,
   the data transmission periods, the communication protocol used by the transmission signal and the data transmitted by the signal, and/or.
   the periods of data reception and the communication channel listened to during these periods.
   the respective durations of the transmission and listening periods,
if the second device 12 receives the Wake-Up Beacon (WuB) wake-up radio signal emitted by the device 11, then the communication module of the second device (12) turns on and communicates according to a set of communications instructions provided in the event of reception of a Wake-Up Beacon (Wub) wake-up radio signal and determining:
   the data transmission periods, the communication protocol used by the transmission signal and the data transmitted by the signal, and/or
   periods of listening to a communication channel,. the respective durations of the broadcast and listening periods.

The instructions are determined by the state in which the device 1 is found, they can for example be:
Emission of a wake-up radio signal (WuB) to another device for a determined duration,
Emission of a wake-up radio signal (Ibeacon) to a third device for a determined duration,
Emission according to the short-range communication protocol of its identifier for a determined period,
Emission according to the short-range communication protocol of its identifier for a determined period,
Emission according to the long-range communication protocol of the list of identifiers received during a determined period,
Search and recovery of the address of a wifi hotspot if the list is empty for a specific period of time.
Listening to the short-range communication channel used for communication between devices 1,
Emission of all shocks experienced (acceleration of too short duration) and/or a temperature by the device during each emission according to the long-range protocol.

The following instructions can be combined together to form a set of instructions.

The method provides for two types of situations for which the decision module defines the state of the device 1.

Either, in a first situation, the decision module 4 defines the state of the device 11 when the accelerometer 3 of the first device 11 detects a movement of the device 11, and then, in this case, the accelerometer 3 of the first device 11 turns on the decision module 4 of the first device 11 and the IA module of the decision module 4 classifies the movement of the device 11 according to the prediction model(s),

Or, in a second situation, the decision module 4 defines the state of the device 11 when the accelerometer of the first device 11 detects an absence of movement for a predetermined duration.

This second situation is typically the moment where the device, whose movement has been classified (first situation), becomes stationary again and where the decision module detects this absence of movement.

According to one embodiment, the set of communications instructions determined by the current state is as follows:
when the first device 11 is in state No. 1, No. 2 or No. 4,
   the communication module 21 of the first device 11 transmits a wake-up radio signal to the second device 12 and an identifier then listens to the short-range communication channel,
   if the communication module 21 receives, via the short-range communication protocol, an identifier of one or more communications devices awakened by the radio wake-up signal emitted, then
   the communication module 21 of the first device 11 sends to the remote server 6, via the long-range communication protocol,
a list of all identifiers received,
a list of all shocks suffered detected by its accelerometer, and.
a timestamp of the list.
when the first device 11 is in state no. 3,
   the communication module 21 of the first device 11 transmits a wake-up radio signal to the third device and sends via the short-range protocol an identifier to the third device

If the device 1 is also equipped with a temperature sensor, then the communication module 21 of the first device 11 can also send to the remote or central server 6 via the long-range communication protocol a temperature of its environment.

Furthermore, if, after transmitting the wake-up radio signal, the communication module 21 does not receive anything via the short-range communication protocol, then the communication module 21 of the first device 11 identifies a nearest wifi transmitter, and sends to the central server 6, via the long-range communication protocol, an identifier of the identified wifi transmitter. Ideally, the first device 11 identifies all nearby wifi transmitters.

Likewise, according to one embodiment, the set of communications instructions provided in the event of reception of a Wake-Up Beacon (Wub) wake-up radio signal is as follows:
the communication module 22 of the second device 12, alternatively, transmits, via the short-range communication protocol, its identifier and listens to the short-range communication channel.

We will now describe an example of a communication method between a first and a second IoT type device, a third smartphone type device as well as a remote or central server.

The process includes the following steps, ie the communications instructions are as follows:
1. if the accelerometer 3 of the first device 11 detects a wake-up event, then
2. the accelerometer 3 of the first device 11 turns on the decision module 4 of the first device 11, then,
3. if the Al module of decision module 4 classifies a movement according to the prediction model(s), then
4. the decision module 4 defines the current state of the device 11, or potentially also its previous state,
5. the decision module 4 turns on and controls the communication module 21 of the first device 11,
6. the communication module 21 transmits a Wakeup Beacon (WuB) radio wake-up signal then transmits its identifier via the short communication protocol,
7. if the second device receives the Wake-Up Beacon (WuB) radio signal, the communication module of the second device turns on, and
8. it sends its identifier to the first device 11 and listens to the first device 11, alternatively, over a predetermined period, via the short-range communication protocol,
9. if the communication module 21 of the first device 11 receives, via the short-range communication protocol, an identifier of one or more communications devices awakened by the wake-up radio signal, then
10. The communication module 21 of the first device 11 sends to the central server 6, via the long-range communication protocol,
a list of all identifiers received,.
a list of all shocks suffered detected by the accelerometer, and
a timestamp of the list

Step 1 is the first step of the cascade ignition of the different modules of the first device 11. The accelerometer detects a wake-up event based on the wake-up event definition. This detection is timestamped.

The accelerometer fulfills its role of lookout for the package 100 and has therefore detected an event previously defined as possibly relevant for logistics monitoring so that it is necessary to turn on the decision module 4 so that it can determine whether the event is relevant or not.

This is step 2: the accelerometer 3 of the first device 11 turns on the decision module 4 of the first device 11,

Once switched on, the decision module 4 of the first device 11 will analyze the measurements transmitted by the accelerometer 3 to classify them and deduce the vehicle which is moving the package 101. With the other information provided by the other sensors, the decision module 4 will deduce the change in state of the device 11 and therefore ultimately of the package 101. If a change of state does not occur, it is considered that the situation of package 101 is unchanged and therefore there is no need to turn on the communication module 2 to transmit the information “the situation of package 101 is unchanged”.

For example, in this embodiment where the device 11 comprises an accelerometer 3, the states of the device 11 are the four mentioned above.

If it turns out that the decision module 4 detects a change of state of the first device 11 (step 4), then the decision module 4 turns on and controls the communication module 21 of the first device 11 (step 5).

For example, for the remainder of the description of the stages of the process, this change of state will be the transition from the “intermediate immobile (Factory or Truck)” state to the “Fenwick” mobility state. However, the steps are unchanged if the state change was the opposite.

At this stage of the process, the deductible information is that the device 11 is set in motion, so that the package 101 is set in motion. It is therefore useful for logistics tracking to know whether responsibility for packaging has been transferred and to whom?

To do this, the communication module 21 transmits a Wake-up Beacon (WuB) radio signal (step 6). For the device 11, the emission of this wake-up radio signal amounts to probing its environment in order to detect at least a second device 12 whose home site is known. The determination of this home site will be detailed below). After having transmitted the WuB wake-up radio signal, it transmits its identifier so that the potential devices 12 awakened by the WuB receive it.

At this stage of the process, two cases are possible: either at least one second device 12 is present in the environment close to the first device 11 or there is none.

In the event of the presence of at least one device 12 nearby, upon receipt of the Wake-Up Beacon (WuB) radio wake-up signal by the second device 12, the communication module 22 of the second device 12 turns on (step 7) and alternatively, it sends to the first device 11, via the short-range communication protocol, its identifier (step 8) and listens to the short-range communication channel in order to receive the identifier transmitted by the first device 11. The sending and listening phases alternate with a predetermined time step. The durations of the listening and sending phases can be equal or different.

In other words, if the second device 12 receives the Wake-Up Beacon (WuB) radio wake-up signal, the communication module of the second device turns on 12 (step 7), and it sends to the first device 11, via the short-range communication protocol, its identifier (step 8).

This communication is done without pairing and without the prior creation of a communication network between the first device 11 and the second device 12. Any device 1 can be a second device 12.

The first device 11 then receives all the identifiers of at least one second device 12 (step 8).

In addition, it is noted that the second devices also receive all the identifiers of the others at least one second device 12 (step 8).

Thus, the information deductible here is that the device 11 is close to the device 12 or even is attached to the same site as the device 12.

If, at a date prior to this operation, the site to which the device 11 or the device 12 is attached is known, and in the meantime, the information reported by the latter make possible to be certain that it has not changed home site, then we are certain that the other device, 11 or 12, is attached to this same site.

The other devices 12 also sending the list of identifiers of the devices in their surroundings, it is possible to identify step by step all the packaging under the responsibility of this site. In fact, a single device previously assigned to the site is sufficient and serves as a reference point for the others.

It is therefore the server 6 which deduces this information from all that sent by the devices 11 and 12, which has a high value.

In step 10: the communication module 21 of the first device 11 sends to the central server 6 via the long-range communication protocol,
a list of all the identifiers received,
a list of all the shocks suffered detected by the accelerometer, and
a timestamp associated with each reception,

As explained above, it has a processing unit capable of collecting all this irrefutable information and aggregating it like a blockchain to assign each package in a legally irrefutable manner, 24/7, to a distribution site. connection.

In fact, the geographical position of the packages is deduced from the position of the industrial site to which it is attached.

Thus each device 11 or 12 becomes a reference point for the others as soon as it has been assigned responsibility for a site, and, moreover, uses the other devices to find its way.

It is the server 6 which is capable of differentiating between the referent devices, ie those already present in a location when the communication method is implemented, and those which are assigned to the same sites as these referents using movement data for each of them.

According to one embodiment, it can be provided that the second device 12 also sends to the first device 11:
A list of identifiers received
The neighborhood table creation timestamp

The neighborhood table includes all the dates and times of reception of the identifiers received by the device 12.

Likewise, then, the communication module 21 of the first device 11, further sends to the central server 6, via the long-range communication protocol, this information (list of identifiers received, timestamp of the creation of the table).

This makes possible to send even more information and to deduce even more precisely the position of the devices 11 or 12 but also to reconstruct in an even more qualitative manner the logistics flow of packages 100 (101 or 102) equipped with devices 11 or 12 since state changes are transmitted.

Indeed, this allows redundancy in the collection of information which aims to prove the home site of the devices 11 or 12 whose long-range transmission would not have been received and/or emitted.

Finally, we can also plan for all detected wake-up events to be transmitted to the central server 6 to further improve the precision of tracking and the reconstitution of the logistics flow.

According to another embodiment, the communications instructions are as follows: in the absence of at least one device 12 nearby, ie if, after transmitting the wake-up radio signal, the communication module 21 does not receive anything via the short-range communication protocol, then,
11. the communication module 21 of the first device 11 identifies a short-range transmitter, for example a wifi transmitter, the closest and collects the identifier of this transmitter, and
12. the communication module 21 sends the collected identifier to the central server, via the long-range communication protocol

The communication module 21 can, in addition, send the list of shocks suffered during this long-range communication.
we remind that the communication module 21 of the first device 11 is, moreover,

configured to communicate according to a Wi-Fi protocol.

If the first device 11 does not receive any identifier from a device 12, this means that it is alone. This is relevant information in itself. However, if he is alone, it is not possible to deduce the site to which it is attached. In this case, ie when the device 11 does not receive any identifier, other information is collected and can make possible to deduce the site to which it is attached:
identifier of the user of the mobile application running on the third device (for example a smartphone) which received a communication from the device.
The position of this user's third device, and/or.
The identifier of the wifi terminal which was collected according to a communication process instruction.

It is possible that server 6 only collects one or more of this information.

This collected information makes possible to determine the list of potential industrial sites to which the packaging for server 6 is attached.

The relevant information deduced here is always the home site of the first device 11. This deduction is carried out by server 6. To do this, the server 6 can use external services such as calculation software available in SaaS (Software-as-a-Service) to determine the position of the first device 11.

In other words, to allow the server 6 to determine the home site, the device 11 will search and identify (step 11) all the short-range wireless transmitters (Wi-Fi for example) and thus the position of the device 11 will be assimilated to the triangulation of the signals emitted by these transmitters. Obviously any other type of short-range transmitter can be used (see the frequency bands used by short-range protocols) without the principle according to which the device 1 searches for transmitters whose position is known so that the server 6 can deduce the site to which the first device 11 is attached and consequently does not change.

This choice of short-range transmitter sought depends on the range of the transmitter sought and the precision of the desired position. For example, it could be a BLE or Bluetooth transmitter.

Indeed, the redundancy of certain information collected (device identifiers 11 or 12 exchanged between them) and the variety of information sources (IoT, wifi terminal, smartphone) make possible to guarantee the reliable and, ultimately legally enforceable, connection of the devices 1 at a site.

If it is not possible to uniquely determine the industrial site responding to the information collected, then a notification is sent to the last user of the application on their third device asking them to choose from the proposed industrial sites.

Once an industrial site has been determined for the device 11, it can serve as a reference point for the other devices 1 located nearby, ie within the range of the short-range communication module around it. It will then have the role of device 12.

We note here that steps 1 to 10 are independent but complementary to steps 11 to 12. The first device 11 of steps 11 to 12 can in fact be a second device 12 of steps 1 to 9.

The communication method according to the invention may provide a third set of steps. These steps take place in the presence of a third communication device 5 as described above.

we remind that this third device 5 has a location module (for example, a GPS module) and a wireless communication module configured to communicate according to the following communication protocols:
the short-range communication protocol,
a telephone communication protocol,

This device 5 is typically a smart phone (smartphone).

The communication process therefore provides for the following steps:
13. the communication module 21 of the first device 11 sends its identifier to the third device 5, via the short-range communication protocol.
14. the third device 5 sends to the remote or central server 6, via the telephone or Wi-Fi communication protocol:
   The application user ID
   the information sent by the first device
   The GPS position of the third device (smartphone) if the user has given

In addition, these steps 13 to 14 provide information on the GPS position of the third device 5 which makes possible to deduce the position of the device 11 but not its home site.

To connect the device to a site, you must cross-reference two pieces of information:
The GPS position of the third device (smartphone).
The site to which the user of the application running on the third device (smartphone) is attached

If the two pieces of information are consistent, then server 6 assigns the packaging

to the site on which the user depends. If this is not the case, this same user must answer the question of the site on which he is located.

It is then possible to reconstruct step by step which device 1 is attached to the same site as another whose home site we know as explained above.

This information (GPS position of the third device 5, The site to which the user of the application operating on the third device (smartphone) is attached) useful for logistical tracking of the packages 100, is transmitted to the central server 6 (step 14) by device 5. Remember that the central server 6 is equipped with a processing unit configured to process all this data. The third device 5 also transmits its position determined by its location module (for example GPS) to the central server 6 (step 14).

Thus, it is possible to deduce that the first device 11 is located next to the device 5, whose home site is known via its user and the position, at a precise time.

The home site cannot be determined by the GPS module of the third device (smartphone) alone, but by crossing this information with the home area and the user's factory, we can even define the factory area where the device is located (for example an operator in the factory).

We therefore note again that the communication steps 12 to 14 are independent and complementary to the communication steps 1 to 9 and 10 to 11.

### Application of the Process

Whatever the embodiment considered or the combination of these embodiments, the communication method is likely to be used in a package tracking method.

Overall, the tracking process amounts to equipping packages 100 with devices 1, collecting the information sent to the central server 6 and processing this information to deduce all the home sites and ultimately reconstruct the home site history of each of the packages 100 equipped with a device 1.

The method is therefore as follows:
each package 100 is equipped with a communication device 1 according to the invention defined above and provided with an identifier and comprising:
according to the communication method according to the invention defined above, a communication is established between:
the communication devices equipping the packages,
a central server and
a communication device comprising:
a wireless communication module configured to communicate according to the following communication protocols:
a short-range communication protocol, a range of this protocol ranging from 0 to 10 meters,
a telephone communication protocol,
a location module,
from the information received by the central server, time-stamped determination of a logistics home site of each package by the central server 6.

The principles for deducing the position of devices 11 or 12 have been given previously.

We place ourselves in the embodiment, purely by way of example, where the long-range protocol used by the device 1 is LORA, where the range of the short-range protocol is approximately 10 m, where the predetermined duration of change of The state of movement at rest is 15 min.

However, we provide an example of deductions that can be made by server 6 from the following tables:

TABLE 1

| | INFORMATION | DEDUCTION |
|---|---|---|
| 1 | a user declares their name and industrial site on | This user is attached to this |
| | the application | industrial site IND |
| 2 | The mobile application of the user of (1) | This packaging is close to the user |
| | receives a signal from a device A | (1) |
| DEDUCTION | | This packaging is under the |
| | | responsibility of the IND site of (1) |
| 3 | The central server 6 has received the file that a | The packaging containing these 1 |
| | device 11 sent by LORA. It contains list of 20 | devices (11 and 12) are less than |
| | devices 12 close to it. | 10 m from each other |
| 4 | One of the devices 1 (11 or 12) in this list is | The group of all these packages is |
| | device A, which is attached to the site by the first | at where this device A is located |
| | deduction | |
| 5 | The information collected and analyzed of this | The initial package A is still on the |
| | A device proves that it did not leave from the | mobile application user's site |
| | industrial site to which it was attached | |
| DEDUCTION | | These 20 packages are currently |
| | | under the responsibility of the IND |
| 6 | The central server 6 has received the file that a | Packages containing these |
| | device 11 sent by LORA. It contains list of 20 | devices are less than 10 m apart |
| | devices 12 in close to it. | from each other |
| 7 | One of the devices 12 belongs to the list of the | Both groups of devices are in the |
| | device which emitted in (3) | same same location. |
| DEDUCTION | | These 40 packs are currently |
| | | under the responsibility of the IND |
| 8 | A few minutes after unloading, (i.e. a change of | Packages containing these |
| | state is detected), a device polls its | devices are less than 10 m apart |
| | surroundings and sends a list of 20 nearby | from each other |
| | devices via LoRa. | |
| 9 | One of the devices on this list belongs to the list | Packages containing these |
| | of (6) | devices are less than 10 m apart |
| | | from each other |

| DEDUCTION | The packs have just been |
|---|---|
| | unloaded at the IND industrial site |
| | in (1) and are therefore attached to |
| | it. |

TABLE 2

| | INFORMATION | DEDUCTION |
|---|---|---|
| 10 | An operator reads a package's NFC tag with a | This packaging is attached to the |
| | device 5 and declares that he is putting it on a | IND2 industrial site |
| | pile of empty packages on the IND2 industrial | |
| | site | |
| 11 | A new package is placed on the stack where | This new packaging being placed |
| | (10) has been placed and its device 11 | on a pile of empties is bound to |
| | interrogates its surroundings. It sends the list | be empty if the factory respects |
| | of nearby devices 12 close to it and contains | its own instructions. |
| | the NFC identifier of (10). | |
| 12 | After loading, the driver scans the tag of a | All this packaging is in a truck |
| | single package using a device 5 and declares | under its responsibility |
| | that it's in his truck using mobile application of | |
| | the device 5. | |
| 13 | A device 11 of a packaging in a truck | Packages containing these |
| | interrogates its surroundings, ie emits a radio | devices are less than 10 m apart |
| | wake-up signal (WuB) and receives 20 | from each other |
| | identifiers of device 12. it sends a list of 20 | |
| | identifiers of device 12 to the server 6. | |
| 14 | The other devices 12 also emit the list of their | By crossing common points, we |
| | surrounding (taking on the role of a device | have a precise and exhaustive list |
| | 11) | of all packaging that is part of the |
| | | load therefore under the |
| | | responsibility of the transport |
| | | company of (12) |
| 15 | The truck stops for more than x min. which | We know the list of packages |
| | triggers the WUR and the sending by the | contained in the stationary truck |
| | devices 1, the list of identifiers of devices in | |
| | their surounding via LoRa | |
| 16 | The truck restarts and drives for more than x | We know the list of packaging |
| | min, which trigger the Wake-Up Radio and the | contained in the truck when |
| | sending by the devices 1, the list the identifiers | restarting and therefore the list of |
| | of devices in their surrounding by LoRa | those that have been |
| | | loaded/unloaded during this stop. |
| 17 | The driver did not switch on his fridge before | We know that goods were loaded |
| | loading. The truck runs X min loaded, which | in a truck at the wrong |
| | trigger the Wake-Up Radio and the sending by | temperature. We can alert the |
| | the devices 1, the list of the identifiers of the | driver by notification, and above all |
| | devices in their surrounding by LoRa. But the | the customer who will receive |
| | temperature is sent with every LoRa | these goods. |
| | communication | |

### Benefits

In the particular implementation of the communication method for logistics tracking of packages, the tracking method according to the invention offers numerous advantages.

The proposed technical solution does not require geolocating packages using a GPS module. It is more reliable than the GPS module in its deduction of the industrial site, does not require the installation of costly infrastructure, and consumes much less energy compared to GPS modules which are sources of planned obsolescence of connected objects (IoT) and therefore electronic pollution.

In addition, the proposed technical solution assigns responsibility for each package or packaging to a participant in the supply chain, which is the key to logistics reliability. This makes possible to reliably assign responsibility for breakage, loss and theft and therefore to reduce misuse.

The proposed solution brings about a real change in philosophy in the world of connected objects.

In fact, known connected objects reproduce an identical action at regular intervals and are turned off in the meantime. They therefore consume a lot of energy to collect worthless information and are sometimes turned off when they should be collecting important information. Indeed, even to light up on data such as temperature, acceleration, etc., the connected object must be turned on and therefore consume energy.

Conversely, the device according to the invention remains on all the time (24/7) but consumes very little in this state. This standby state allows you not to miss anything, and only serves to turn on the device according to the invention when it considers that it will be useful.

Furthermore, it is the device which decides autonomously on the actions to be undertaken thanks to the decision module.

In addition, the communication process does not require the creation of a cluster. Thus, it is not necessary to predict which devices will communicate with each other beforehand, which is very useful since all packages can be interchanged and any new package equipped with a device is directly capable of communicating with other packages (and therefore to be tracked thanks to the tracking process based on the communication process).

### Benefits

From a more general point of view, the invention provides or allows the following advantages:

A device (connected object) which is aware of its movements and which differentiates the movements of the vehicles transporting it: for example, it differentiates the movement of the truck from that of the Fenwick thanks to the Al module.

A device, connected object, which is aware of its environment which it probes: other devices nearby, wifi terminals nearby, smartphones nearby

A device that adapts to its environment and analyzes it to make the right decisions in a 100% autonomous manner based on the states identified autonomously.

A connected device that only transmits information that has value, when it should generate an action by users:
The list of shocks is collected continuously but only sent during long range transmissions
The device only collects and sends the description of its environment when it knows that it has changed, because it is information that it controls thanks to the detection of changes of state and/or reception of alarm clock signals (Wake-Up Radio).
The device sends the list of WiFi terminals near it rather than the list of nearby devices when it has not received a response to its radio Wake-Up signal.

A connected device that adapts its behavior to its environment
It can know when it is in a truck and in this case, it only lights up during stops, and, when it is moving, it reverses the rules to light up according to the first and second situations in which the decision module defines the state of the system.
It can know when it is in a truck and in this case, it seeks to communicate with the driver's smartphone and not with other devices

A device capable of collecting the completeness of the events it undergoes and remaining turned off as often as possible to save its battery

Devices are only woken up when they need to inform others and do not need to stay awake in case relevant information arrives.

The accelerometer is on permanent standby and does not miss any movement of the packaging

The cascade awakening following an acceleration of intensity greater than a predetermined threshold differentiates a shock (recorded) from a movement

Furthermore, the invention makes possible to:
Use devices as a reference point in relation to each other
   Assign the person responsible for one packaging to another packaging by deducing it from the information collected by the 2 devices
   Aggregate information in the manner of a blockchain in order to provide legally enforceable proof of the responsibility under which the device is placed
Collect information through multiple channels and aggregate it based on time and source to define a history individualized to each device
   By a LoRa provider to recover what is emitted by the devices 1, and/or
   By an application embedded on third devices (smartphones).

1. A communication device which can be in several different states and comprising:
a wireless communication module configured to communicate according to the following communication protocols:
a short-range communication protocol,
a range of this protocol ranging from 0 to 10 meters,
a long-range communication protocol,
a range of this protocol ranging from 1 to 20 km,
a Wake-Up Radio (WUR),
an accelerometer (3) configured to measure an acceleration of the device,
a computerized decision module comprising a computerized AI module for classifying a movement configured to classify a movement of the device according to at least one acceleration of the device measured by the accelerometer,
the computerized decision module being configured:
to determine a state of the device based on a movement of the device classified by the computerized AI module for classifying a movement, and
to control the wireless communication module and/or the Wake-Up Radio (WUR) according to a set of communication instructions defined by a determined state of the device.

2. The communication device according to claim 1 in which the states are chosen from:
State no 1 in which the device is stationary in a first stationary vehicle.
State no 2 in which the device undergoes the movement of the first vehicle.
State no 3 in which the device undergoes the movement of a second vehicle, and
State no 4 in which the device is stopped.

3. The communication device according to claim 1 according to which a movement of the device is characterized by an exceeding of a predetermined acceleration threshold at a predetermined frequency of occurrence, and/or by several exceedances of a threshold and/or a predetermined acceleration variation threshold at a predetermined frequency of occurrence.

4. A system comprising:
at least two communications devices each according to claim 1, a third communication device comprising a wake-up radio, a location module and a wireless communication module capable of communicating according to the following communication protocols:
the short-range communication protocol,
a telephone communication protocol, And
a remote server.

5. A method of communication between:
a first device and a second device according to claim 1, and
a third device,
a remote server
the method comprising the following steps:
the decision module defines the state of the first device, the decision module turns on and controls the communication module of the first device according to a set of communications instructions defined by the current state and determines:
the periods of transmission of a Wake-Up Beacon (WuB) wake-up radio signal,
the data transmission periods, the communication protocol used by the transmission signal and the data transmitted by the signal,
the periods of data reception and the communication channel listened to during these periods, and/or
the respective durations of the transmission and listening periods, if the second device receives the Wake-Up Beacon (WuB) wake-up radio signal emitted by the first device, then the communication module of the second device lights up and communicates according to a set of communications instructions provided in the event of reception of a Wake-Up Beacon (Wub) radio signal and determines:
the data transmission periods, the communication protocol used by the transmission signal and the data transmitted by the signal, and/or periods of listening to a communication channel, and/or the respective durations of the transmission and listening periods.

6. The method according to claim 5 according to which
the decision module defines the state of the first device when the accelerometer of the first device detects a movement of the first device, and then, the accelerometer of the first device turns on the decision module of the first device and the computerized AI module for classifying a movement of the decision module classifies the movement of the device according to the prediction model(s), or
the decision module defines the state of the device when the accelerometer of the first device detects an absence of movement for a predetermined duration.

7. The method according to claim 5 according to which the set of communications instructions determined by the current state is the following:
when the first device is in state no 1, no 2 or no 4,
the communication module of the first device transmits a wake-up radio signal to the second device and an identifier and then listens to the short-range communication channel,
if the communication module receives, via the short-range communication protocol, an identifier of one or more communications devices awakened by the radio wake-up signal emitted, then
the communication module of the first device sends to the remote server, via the long-range communication protocol,
a list of all the identifiers received,
list of all the shocks suffered detected by its accelerometer, and
a timestamp of the list.
when the first device is in state no. 3,
the communication module of the first device transmits a wake-up radio signal to the third device and sends via the short-range protocol an identifier to the third device.

8. The method according to claim 5 according to which the set of communications instructions provided in the event of reception of a
Wake-Up Beacon (Wub) wake-up radio signal is the following:
the communication module of the second device, alternatively,
transmits, via the short-range communication protocol, its identifier and
listens to the short-range communication channel.

9. The method according to which the set of communications instructions determined by the current state further comprises the following instruction:
if, after transmitting the wake-up radio signal, the communication module does not receive anything via the short-range communication protocol, then, the communication module of the first device identifies a nearest wifi transmitter, and sends to the central server, via the long-range communication protocol, an identifier of the identified nearest wifi transmitter.

10. A method for tracking objects in a logistics fleet comprising the following steps:
each object is equipped with a communication device according to claim 1 provided with an identifier,
a third device is provided,
a remote server is provided,
the method for tracking objects comprising the following steps,
communication according to the communication method between the remote server, the third device and the devices equipping the objects,
from the information received by the remote server according to the communication method, time-stamped determination of a logistics site of attachment of each package by the remote server.

11. The method according to claim 6 according to which the set of communications instructions determined by the current state is the following:
when the first device is in state no 1, no 2 or no 4,
the communication module of the first device transmits a wake-up radio signal to the second device and an identifier and then listens to the short-range communication channel,
if the communication module receives, via the short-range communication protocol, an identifier of one or more communications devices awakened by the radio wake-up signal emitted, then
the communication module of the first device sends to the remote server, via the long-range communication protocol,
list of all the identifiers received,
list of all the shocks suffered detected by its accelerometer, and
a timestamp of the list.
